(19) United States
(12) Patent Application Publication
(10) Pub. No.: US 2017/0014849 A1
(43) Pub. Date: Jan. 19, 2017

(54) HANDHELD SHOWER AND THE MATCHING CRADLE THEREOF

(71) Applicants: Huasong ZHOU, Xiamen (CN); XIAMEN SOLEX HIGH-TECH INDUSTRIES CO., LTD., Xiamen (CN)

(72) Inventors: Yong GAO, Xiamen (CN); Gangqiang WU, Xiamen (CN); Tao CAI, Xiamen (CN)

(73) Assignees: XIAMEN SOLEX HIGH-TECH INDUSTRIES CO., LTD., Xiamen (CN); Huasong ZHOU, Xiamen (CN)

(21) Appl. No.: 14/802,653

(22) Filed: Jul. 17, 2015

(51) Int. Cl. B05B 15/06; B05B 1/18

(52) U.S. Cl. CPC B05B 15/061; B05B 1/185; B05B 15/065

(57) ABSTRACT

A handheld shower and matching cradle includes a cradle component with a first magnetic element therein and a handheld shower component with a second magnetic element therein. The first magnetic element and the second magnetic element attract each other to make the handheld shower component attached to the cradle component. The cradle component has a first metal piece attracted to the first magnetic element. The handheld shower component has a second metal piece attracted to the second magnetic element; the first metal piece, the first magnetic element, the second magnetic element and the second metal piece disposed and placed one by one. The first metal piece is attracted to the first magnetic element, the second metal piece is attracted to the second magnetic element.

### FIELD OF THE INVENTION

The present invention relates to a handheld shower and the matching cradle thereof.

### BACKGROUND OF THE INVENTION

There are various showers that can be divided to fixed shower and handheld shower according to the assembly structure of the handle. As the handle of the fixation shower is fixedly connected to the base body, and the outlet has fixed direction, the shower is used inconveniently. The handle of the handheld shower is detachably inserted to the base body, the handle can be taken down to move, which makes the shower used with convenience. However, handle of existing known handheld showers is connected to the base body by plug connection method, so that the structure is single without other choices, which can not satisfy the consumer's needs.

### SUMMARY OF THE INVENTION

The present invention provides with a handheld shower and the matching cradle thereof, which overcomes the disadvantages of the existing known technology. The technical proposal of the present invention to solve the technical problems is that:

A handheld shower and the matching cradle thereof, comprising:

a cradle component with a first magnetic element therein;

a handheld shower component with a second magnetic element therein;

the first magnetic element and the second magnetic element attracting each other to make the handheld shower component attached to the cradle component;

wherein the cradle component disposed with a first metal piece attracted to the first magnetic element, the handheld shower component disposed with a second metal piece attracted to the second magnetic element; the first metal piece, the first magnetic element, the second magnetic element and the second metal piece disposed and placed one by one.

In another preferred embodiment, the cradle component is disposed with a first locking connecting part, and the handheld shower component is disposed with a second locking connecting part, the first locking connecting part and second locking connecting part are contacted to each other when the handheld shower component is attached to the cradle component.

In another preferred embodiment, the second locking connecting part is a hung part disposed in the handheld shower component and the first locking connecting part is a support part disposed in the cradle component, the hung part is hung to the support part.

In another preferred embodiment, the handheld shower component comprises a hand and a pressure cover, the pressure cover presses the second magnetic element on the handle, the second locking connecting part is disposed on the pressure cover; the cradle component comprises a fixation base and an end cover, the end cover presses the first magnetic element on the fixation base, the first locking connecting part is disposed in the fixation base.

In another preferred embodiment, the hung part is an arc shaped rib structure.

In another preferred embodiment, the center of the pressure cover is disposed with a throughout hole corresponding to the second magnetic element, the center of the end cover is disposed with a throughout hole corresponding to the first magnetic element.

In another preferred embodiment, the handheld shower component further comprises a cap and a sealing pad, the cap covers the second magnetic element, the pressure cover covers the cap, the sealing pad is disposed between the second metal piece and the handle. In another preferred embodiment, the cradle component further comprises a cap and a sealing pad, the cap covers the first magnetic element, the end cover presses on the cap, the sealing pad is disposed between the first metal and the fixation base.

In another preferred embodiment, the first metal piece and the second metal piece are iron sheet.

Compared to the existing technology, the present invention has advantages as follows:

1. The first metal piece is attracted to the first magnetic element, the second metal piece is attracted to the second magnetic element, so that it can greatly increase the attraction of the first magnetic element and the second magnetic element, thus making the handheld shower component stably connected to cradle component.

2. Two locking connecting parts are contracted to each other, when the handheld shower component is pulled down, the second locking connecting part bears certain force and doesn't drop down from the cradle component. Therefore, with the first magnetic element and the second magnetic element, the handheld shower component is stably connected to the cradle component in the attraction direction, with the locking connecting parts, the handheld shower component can bear some force in the direction vertical to the attraction, so that the handheld shower component is stably and reliably connected to the cradle component.

3. The center of the pressure cover is disposed with throughout hole according to the second magnetic element, the second magnetic element is embedded to the throughout hole; the center of the end cover is disposed with throughout hole according to the first magnetic element, the first magnetic element is embedded to the throughout hole, it shortens the distance of the first magnetic element and the second magnetic element, thus increasing the attraction of the two magnetic elements.

### BRIEF DESCRIPTION OF THE DRAWINGS

The present invention will be further described with the drawings and the embodiment.

FIG. 1 illustrates a schematic diagram of the handheld shower of the present invention.

FIG. 2 illustrates a schematic and exploded diagram of the handheld shower of FIG. 1.

FIG. 3 illustrates a sectional diagram of the handheld shower of FIG. 1.

FIG. 4 illustrates another sectional diagram of the handheld shower of FIG. 1.

### DETAILED DESCRIPTION OF THE EMBODIMENTS

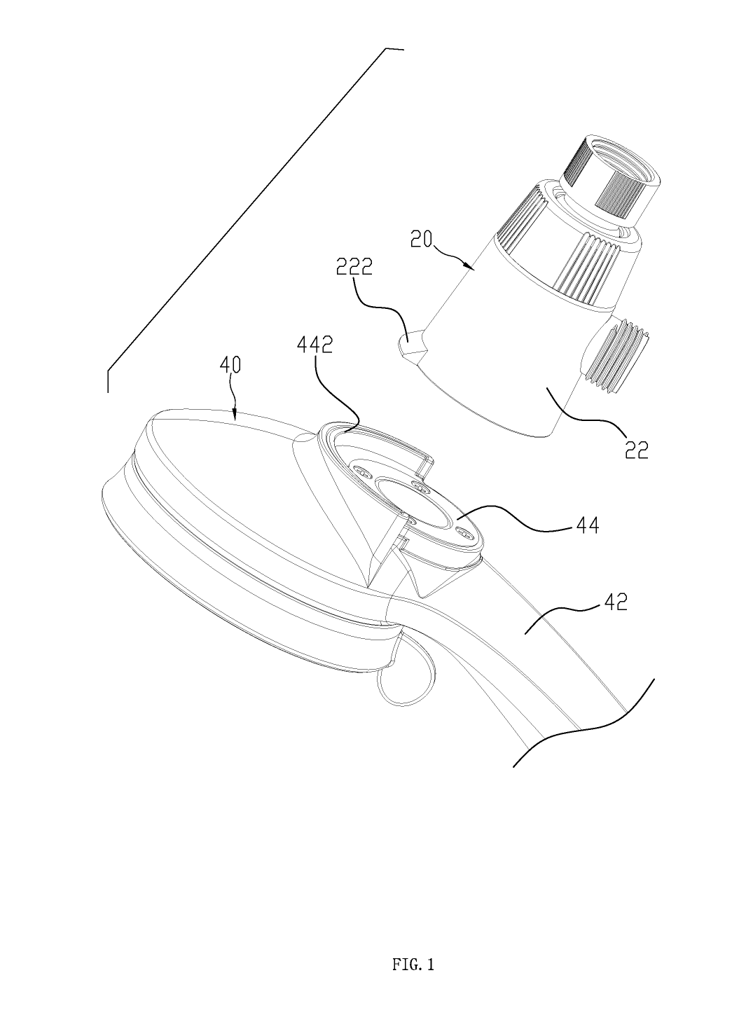

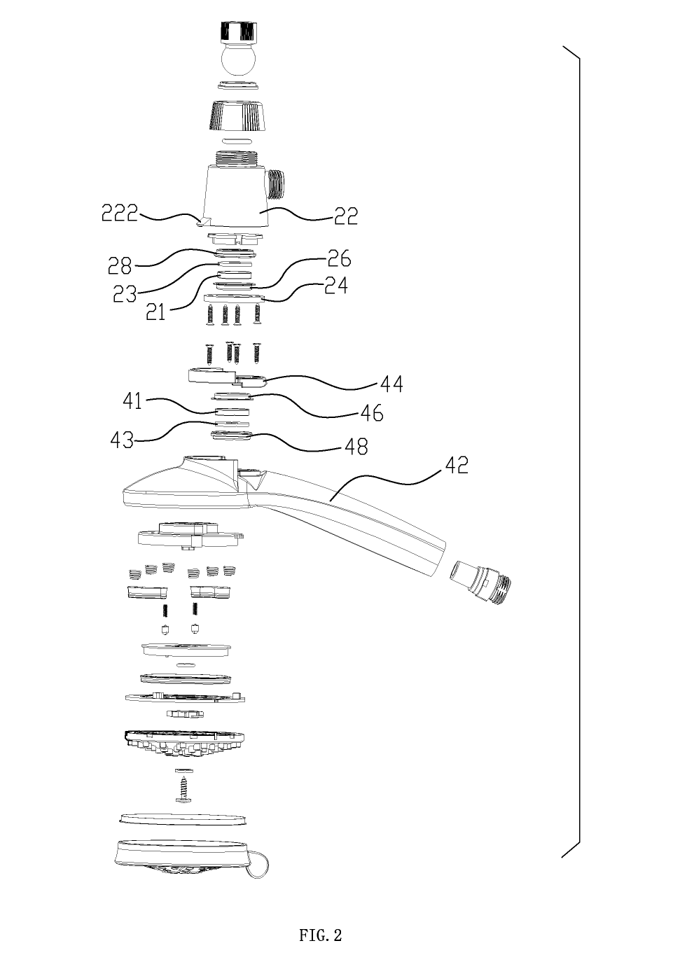

Referring to FIG. 1 and FIG. 2, a handheld shower of the present invention comprises a cradle component 20 disposed to the wall and a handheld shower component 40. The cradle component 20 is disposed with a first magnetic element 21 and a first metal piece 23 therein. The handheld shower component is disposed with a second magnetic element 41 and a second metal piece 43. From top to bottom, the first metal piece 23, the first magnetic element 21, the second magnetic element 41 and the second metal piece 43 are disposed one by one. The first magnetic element 21 and the second magnetic element 41 are attracted each other and cooperated to make the handheld shower component 20 connected to the cradle component 40.

Preferably, the first metal piece 23 and the second metal piece 43 are iron sheet.

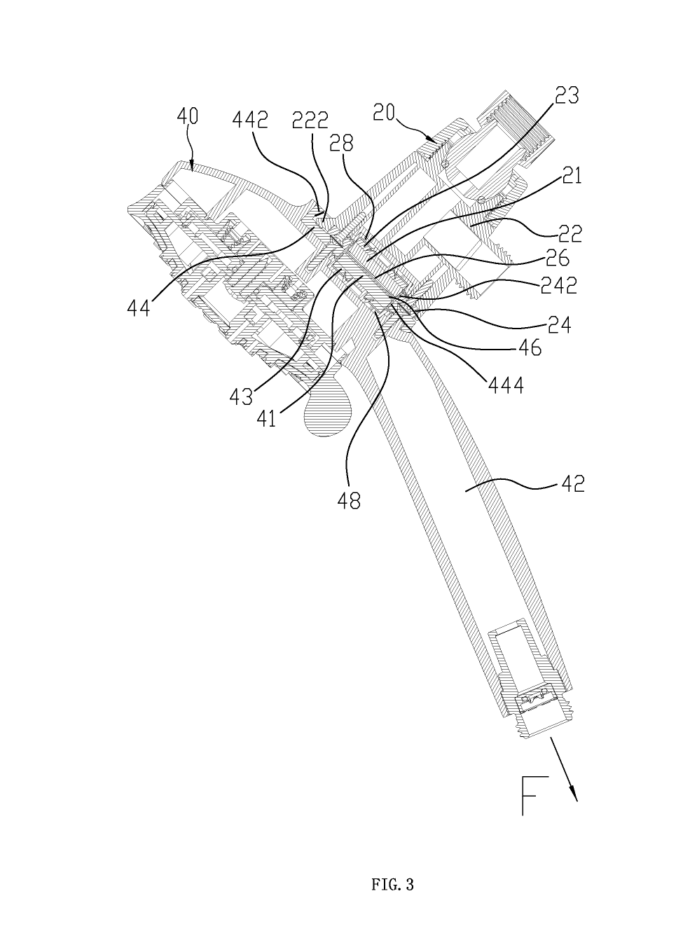

Referring to FIG. 2 and FIG. 3, the handheld shower component 40 further comprises a handle 42, a pressure cover 44, a cap 46 and a sealing pad 48. The pressure cover 44 is disposed with a second locking connecting part 442, the second locking connecting part 442 is preferably a hung part. The second locking connecting part 442 is disposed at the upper edge of the pressure cover 44 and is arc rib structured. The center of the pressure cover 44 is disposed with a throughout hole 444 corresponding to the second magnetic element 41. The cap 46 covers the second magnetic element 41, the sealing pad 48 is disposed between the second metal piece 43 and the handle 42, the pressure cover 44 presses the cap 46 so as to fix the second magnetic element 41 to the handle 42, the second magnetic element 41 is embedded to the throughout hole 444.

The cradle component 20 further comprises a fixation base 22, an end cover 24, a cap 26 and a sealing pad 28. The upper part of the external wall of the fixation base 22 is disposed with a first locking connecting part 222, the first locking connecting part 222 is preferably a support part. The center of the end cover 24 is disposed with a throughout hole 242 corresponding to the first magnetic element 21. The sealing pad 28 is disposed between the first metal piece 23 and the fixation base 22, the cap 26 covers the first magnetic element 21, the end cover 24 presses the cap 26, the first magnetic element 21 is embedded to the throughout hole 242, the end cover 24 presses the first magnetic element 21 to the fixation base 22.

When the shower component 40 gets near to the cradle component 20, two magnetic elements 21, 41 attracts each other to make the shower component 40 fixed to the cradle component 20. The first locking and connecting part 222 and the second locking and connecting part 442 are contacted to each other. To take the shower component 40 out, it only needs to apply force to the shower component 40 in the direction of the cradle component 20 to overcome the attraction of the two magnetic elements 21, 41.

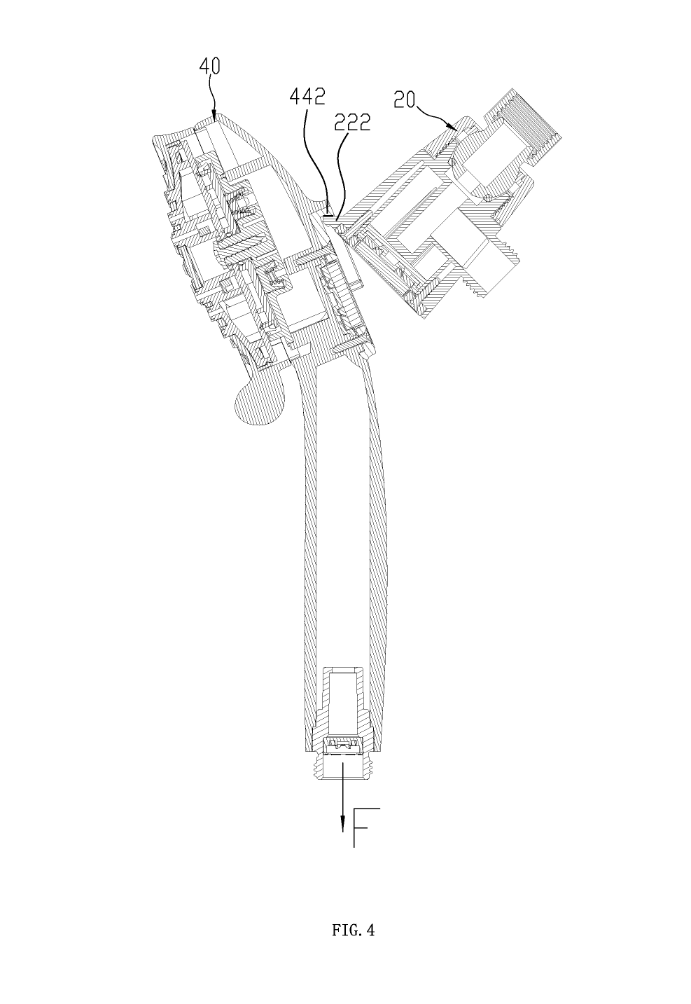

Referring to FIG. 4, when the handle 42 is pulled down by external force, the second locking connecting part 442 can be hung and locked to the first locking connecting part 222, so that the shower component 40 can swing about first locking connecting part 222 which servers as a pivot point, thus avoiding the handheld shower component 40 from falling down.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A handheld shower and the matching cradle thereof, comprising:
a cradle component with a first magnetic element therein;
a handheld shower component with a second magnetic element therein;
the first magnetic element and the second magnetic element attracting each other to make the handheld shower component attached to the cradle component;
wherein the cradle component disposed with a first metal piece attracted to the first magnetic element, the handheld shower component disposed with a second metal piece attracted to the second magnetic element; the first metal piece, the first magnetic element, the second magnetic element and the second metal piece disposed and placed one by one.

2. The handheld shower and the matching cradle thereof according to claim 1, wherein the cradle component is configured with a first locking connecting part and the handheld shower component is configured with a second locking connecting part, the first locking connecting part and second locking connecting part are contacted to each other when the handheld shower component is attached to the cradle component.

3. The handheld shower and the matching cradle thereof according to claim 2, wherein the second locking connecting part is a hung part disposed in the handheld shower component and the first locking connecting is a support part disposed in the cradle component, the hung part is hung to the support part.

4. The handheld shower and the matching cradle thereof according to claim 2, wherein the handheld shower component comprises a hand and a pressure cover, the pressure cover presses the second magnetic element on the handle, the second locking connecting part is disposed on the pressure cover; the cradle component comprises a fixation base and an end cover, the end cover presses the first magnetic element on the fixation base, the first locking connecting part is disposed in the fixation base.

5. The handheld shower and the matching cradle thereof according to claim 3, wherein the hung part is an arc shaped rib structure.

6. The handheld shower and the matching cradle thereof according to claim 4, wherein the center of the pressure cover is disposed with a throughout hole corresponding to the second magnetic element, the center of the end cover is disposed with a throughout hole corresponding to the first magnetic element.

7. The handheld shower and the matching cradle thereof according to claim 5, wherein the handheld shower component further comprises a cap and a sealing pad, the cap covers the second magnetic element, the pressure cover covers the cap, the sealing pad is disposed between the second metal piece and the handle.

8. The handheld shower and the matching cradle thereof according to claim 5, wherein the cradle component further comprises a cap and a sealing pad, the cap covers the first magnetic element, the end cover presses on the cap, the sealing pad is disposed between the first metal and the fixation base.

9. The handheld shower and the matching cradle thereof according to claim 1, wherein the first metal piece and the second metal piece are iron sheet.
